(19) United States
(12) Patent Application Publication
(10) Pub. No.: US 2015/0272832 A1
(43) Pub. Date: Oct. 1, 2015

(54) PACIFIER STORAGE DEVICE AND METHOD OF USING SAME

(71) Applicant: Nevin Diamond, Long Beach, NY (US)

(72) Inventor: Nevin Diamond, Long Beach, NY (US)

(21) Appl. No.: 14/671,100

(22) Filed: Mar. 27, 2015

Related U.S. Application Data
(60) Provisional application No. 62/064,743, filed on Oct. 16, 2014.
(60) Provisional application No. 61/971,209, filed on Mar. 27, 2014.

(51) Int. Cl. A61J 17/00

(52) U.S. Cl. CPC A61J 17/008; A61J 17/001

(57) ABSTRACT

A combination pacifier and storage device and method of same are provided. The device includes a pacifier having a nipple, having a distal end having a sucking portion, and a proximal end having a shank portion, and a guard that extends laterally outward from the proximal end adjacent the shank portion. The device includes a storage container including a housing having an elongated opening with arcuate top and bottom ends and oppositely orientated outwardly extending protrusions of particular shape to accommodate the sucking portion of the nipple. The device includes means for removably connecting the container to an object or body part.

### CROSS-REFERENCES TO RELATED APPLICATIONS

This application claims the benefit of provisional patent application Ser. No. 61/971,209 filed in the United States Patent and Trademark Office on Mar. 27, 2014, and also provisional patent application Ser. No. 62/064,743 filed in the United States Patent and Trademark Office on Oct. 16, 2014, the entirety of both disclosures are incorporated by reference herein.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE EFS-WEB

Not applicable.

### STATEMENT REGARDING PRIOR DISCLOSURES BY THE INVENTOR OR A JOINT INVENTOR

Not applicable.

### SEQUENCE LISTING

Not applicable.

### BACKGROUND OF THE INVENTION

1. Field of the Invention

This invention relates to a pacifier storage device, and more particularly, to a portable and sanitary pacifier storage device and method of using same, that removably connects to an object or body part.

2. Description of the Related Art

Pacifiers are well known for providing infants and young children a safe and soothing alternative to sucking on their thumb. Pacifier's sooth and calm young babies, helping them to relax and feel secure, while preventing irritability and upset from hunger, wetness or discomfort.

Pacifiers generally include a guard portion, which is constructed of rubber, plastic, or silicon material and a nipple or teat. They are commonly made from material which combines resistivity and resiliency to provide a surface best suited to satisfy the sucking urge of children.

While pacifiers are extremely helpful for parents and caretakers, they are only useful when readily available. Finding a clean pacifier when a baby needs it most can be challenging, because they are too often lost or misplaced. There is therefore a need for a portable storage device that enables a parent to store and easily retrieve a pacifier.

Additionally, because pacifiers are held in the mouth of infants, they must constantly be monitored for cleanliness. Currently, pacifiers are stored in diaper bags, purses or pockets, which are extremely dirty environments. It is therefore necessary to provide a device that enables a pacifier to be stored in a sanitary and sterile compartment.

It is a primary object of the present invention to provide a portable and sanitary pacifier storage device and method of using same, that removably connects to an object or body part.

It is another object of the present invention to provide a storage device that protects a pacifier from dirt and contaminants, and can easily be cleaned and sterilized.

It is another object of the present invention to provide a storage device having means for sanitarily housing and securing the sucking part of a pacifier.

It is another object of the present invention to provide a storage device having means for removably connecting it to an object or a body part, including a bracelet, necklace, rope, band, string or chain.

It is another object of the present invention to provide a storage device capable of being transported with a pacifier therein.

It is another object of the present invention to provide a storage device having a manual opening and closing means to enable the user to clean the device.

It is another object of the present invention to provide a storage device capable of providing quick release for efficiently removing the pacifier from the housing.

### BRIEF SUMMARY OF THE INVENTION

In accordance with one aspect of the present invention, a pacifier storage device is provided for protecting a pacifier from contaminants, where the pacifier has a nipple portion and guard portion. The device includes means for sanitarily housing the nipple portion of the pacifier, means for securely receiving and locking the nipple portion of the pacifier with the housing, and means for removably connecting the housing to an object or body part.

In accordance with an additional embodiment, a combination pacifier and storage device is provided. The pacifier has a nipple having a distal end having a sucking portion and a proximal end having a shank portion, and a guard that extends laterally outward from the proximal end adjacent the shank portion. The housing has an interior cavity and at least one correspondingly shaped opening to receive the sucking portion of the nipple therethrough, wherein the opening includes means for removably securing the nipple portion within the interior cavity of the housing.

The device may include a base portion. The base portion may include means for removably connecting the housing to an object or body part. The removably connecting means may be a slot or opening for accommodating a fastening member. The fastening member may be from the group consisting of bracelet, necklace, rope, band, string, or chain. The base portion may be hingedly connected to the housing for opening and closing the interior cavity of the housing. The housing may be freestanding. The device may include a toy, object or item having a correspondingly shaped cavity adapted to receive the housing therein. The opening may be elongated in shape and have arcuate top and bottom ends. The securing means of the opening may include oppositely orientated outwardly extending protrusions of particular shape to accommodate and securing the sucking portion of the nipple within the interior cavity of the housing.

In accordance with an additional embodiment, a combination pacifier and storage device is provided, wherein a pacifier has a nipple having a distal end having a sucking portion and a proximal end having a shank portion, and a guard that extends laterally outward from the proximal end adjacent the shank portion. A storage container includes a housing having an elongated opening with arcuate top and bottom ends and oppositely orientated outwardly extending protrusions of particular shape to accommodate the sucking portion of the nipple. The device includes means for removably connecting the container to an object or body part.

The storage container may have a base portion hingedly connected to the housing. The base portion may include means for connecting the container to an object or body part. The storage container may be freestanding.

In accordance with an additional embodiment, a method of securely storing a pacifier within a sanitary housing is provided. The steps include providing a nipple having a sucking portion and a guard portion, then providing a housing having opening means adapted to receive the sucking portion of the nipple. Then, positioning the sucking portion of the nipple with the correspondingly shaped opening of the housing, then inserting the sucking portion through the opening and into an interior cavity of the housing. Then, turning the guard portion of the nipple rotationally to capture the sucking portion within the interior cavity of the housing.

The sucking portion may be positioned entirely within the interior cavity of the housing. By manually turning the guard portion of the pacifier the sucking portion may be locked within the housing. The sucking portion may be released from the housing by manually rotating the guard portion and uncapturing the sucking portion from within the interior cavity of the housing. The steps may further comprise removably connecting the housing by a fastening means to an object or body part.

### BRIEF DESCRIPTION OF THE SEVERAL VIEWS OF THE DRAWINGS

To these and to such other objects that may hereinafter appear, the present invention relates to a portable and sanitary pacifier storage device and method of using same as described in detail in the following specification and recited in the annexed claims, taken together with the accompanying drawings, in which like numerals refer to like parts in which:

FIG. 1 is a perspective view of a pacifier storage device showing a pacifier stored within a housing connected to a fastening member, in accordance with the preferred embodiment of the present invention;

FIG. 2 is an exploded view of the pacifier storage device showing the pacifier positioned for entry into the housing, in accordance with the preferred embodiment of the present invention;

FIG. 3 is a front plan view of the housing showing an opening means and base portion, in accordance with the preferred embodiment of the present invention;

FIG. 4A is a bottom plan view of the housing showing the hingedly connected base portion in an opened position, in accordance with the preferred embodiment of the present invention;

FIG. 4B is a bottom plan view of the housing showing the hingedly connected base portion in a closed position, in accordance with the preferred embodiment of the present invention;

FIG. 5 is a cross-sectional view of the pacifier stored with the housing of the pacifier storage device taken along line 5-5 of FIG. 1;

FIG. 6 is a bottom plan view of the pacifier storage device of FIG. 1;

FIG. 7 is a side elevation view of the pacifier storage device of FIG. 1; and

FIG. 8 is a perspective view of the pacifier storage device worn on the wrist of a user by the fastening means, illustrating the method for securing the pacifier within the housing, in accordance with the preferred embodiment of the present invention.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### DETAILED DESCRIPTION OF THE INVENTION

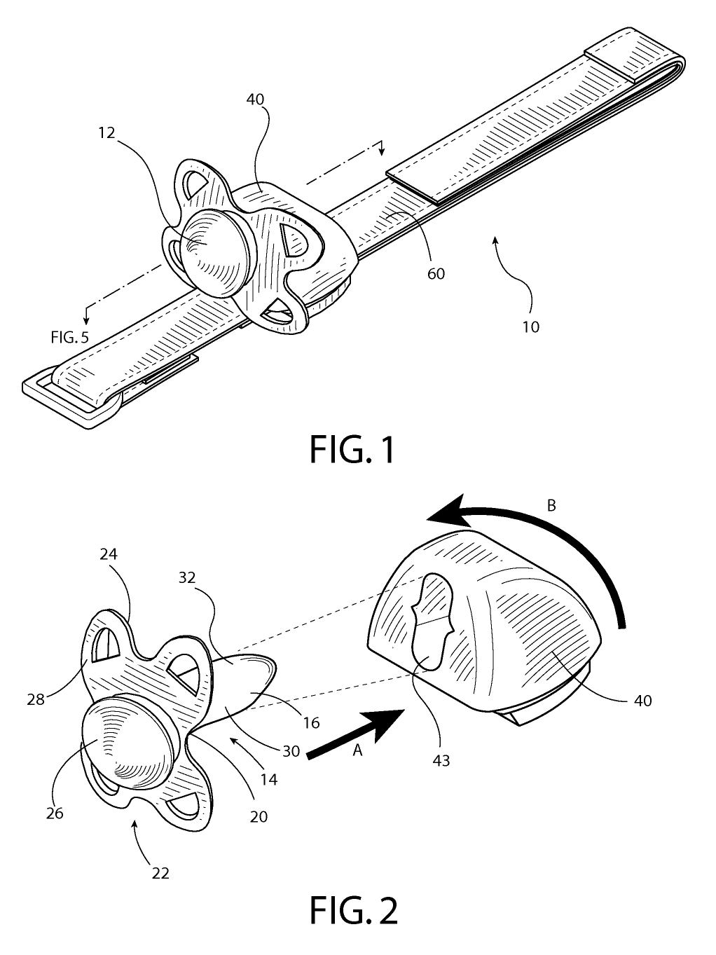

FIG. 1 illustrates a pacifier storage device 10 for storing, transporting, and protecting a pacifier 12 from contaminants and dirt while not in use. In it's broadest context, the device 10 includes in combination, a pacifier 12, a storage container 38 including a housing 40 for storing the pacifier, and a fastening means 60 for removably connecting the housing to an object, item, or body part.

FIG. 2 illustrates the pacifier 12, which includes a nipple 14 having a distal end 16 having a sucking portion 30, and a proximal end 20 having a shank portion 32. The proximal end 20 attaches to a guard 22 that extends laterally outward from the nipple 14, such that the nipple cannot be swallowed or ingested into the infant's mouth beyond the proximal end 20. The guard 22 includes a first side 24, which attaches to the proximal end of the nipple, and presses against the mouth and face of the infant and prohibits the infant from swallowing and choking on the pacifier. The guard 22 includes a second side 26, which may include a handle 28 or other grasping or fastening means.

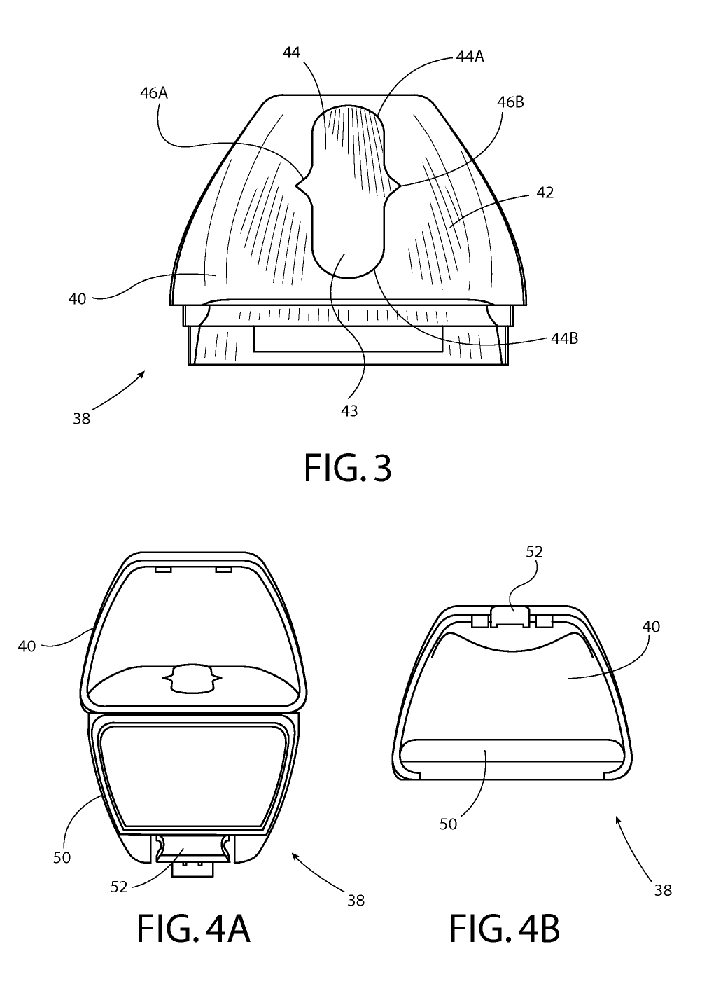

FIG. 3 illustrates the storage container 38 having the housing 40, which is a substantially enclosed freestanding container having at least one wall 42 defining an interior cavity 43. Preferably, the housing is approximately 1.75″ in width, 26″ in height, and 1.22″ in length. Various other configurations, shapes and designs are contemplated and included herein, including housing configurations in the shape of an animal, cartoon character, car, truck, ball, symbol, character or any other shape or design containing an internal cavity.

An opening 44 extends through the wall 42 of the housing 40 and is shaped to receive the sucking portion of the nipple. Preferably, the opening 43 is an elongated oval having arcuate top 44A and bottom ends 44B and an opening means 46 for removably securing the nipple portion within the interior cavity 43 of the housing. Preferably, the opening means 46 includes two oppositely orientated outwardly extending protrusions 46A, 46B of particular shape to accommodate receipt of the sucking portion of the nipple therethrough and into the interior cavity 43 of the housing.

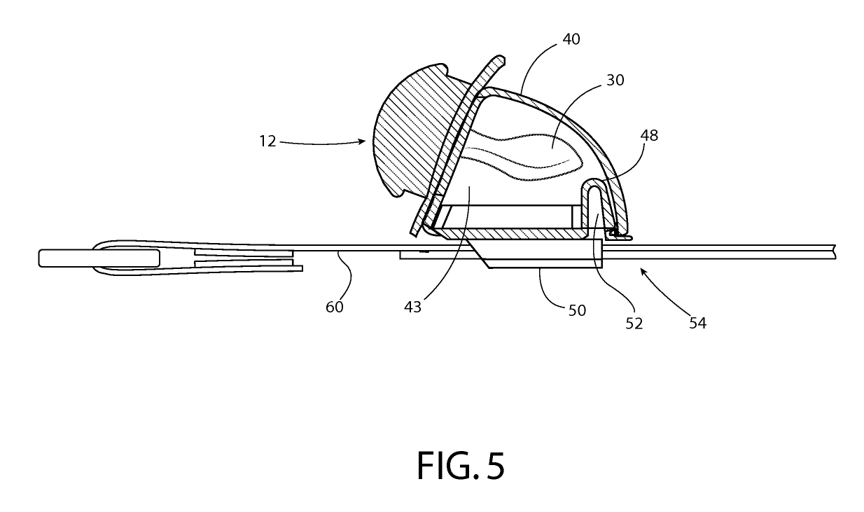

FIGS. 4A and 4B illustrate the storage container 38, which includes a base portion 50 hingedly connected to the housing 40 for manually opening and closing the housing such that the interior cavity 43 is exposed for cleaning and disinfecting. FIG. 4A illustrates the base portion 50 in an opened or unlatched position, while FIG. 4B illustrates the base portion 50 in a closed or latched position. The base portion includes a latch 52 for securing to one wall 42 of the housing, which wall 42 preferably includes a strike or plate 48 (shown in FIG. 5).

FIG. 5 illustrates a cross-sectional view of the present invention, including locking means 54 comprising the latch 52 of the base portion 50 and the strike 48 of the housing 40. The sucking portion 30 of the pacifier 12 is shown secured within the interior cavity 43 of the housing 40.

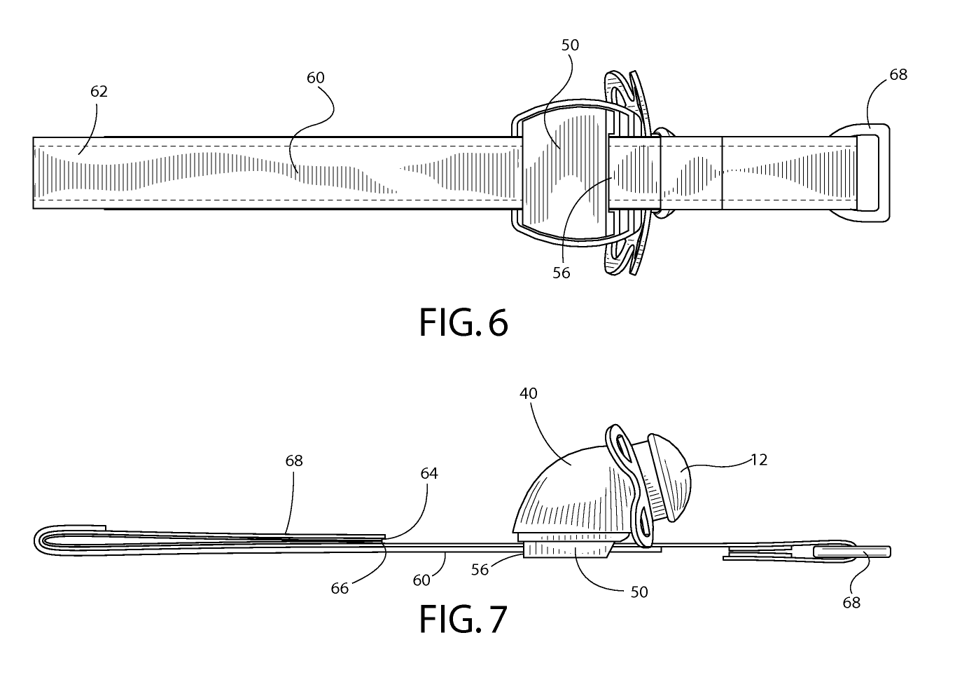

FIGS. 6 and 7 illustrates the base portion 50, which includes means 56 for removably connecting the housing 40 to an object or body part, preferably means includes at least one slot or opening for accommodating the fastening member 60.

The fastening member 60 is shown as an adjustable wristband, but alternate fastening members are contemplated and considered as part of the present invention. Contemplated fastening members include, but are not limited to, bracelet, necklace, rope, band, string, or chain.

Preferably the fastening member 60 includes a distal end 62, hook portion 64, a loop portion 66, and an adjustment mechanism 68, such that the distal end 62 is threaded through the adjustment mechanism 68 and the hook and loop portions 64, 66 are matingly engaged as desired for selectively securing the fastening member to a wrist, other body part, object or item.

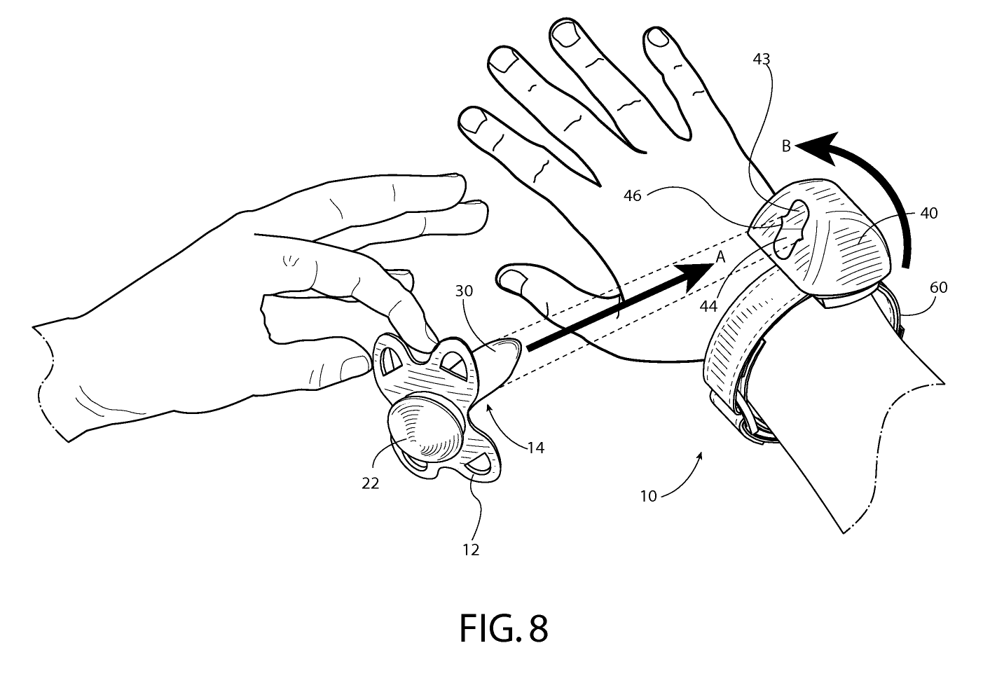

FIG. 8 illustrates a preferred method of using the pacifier storage device 10 of the present invention to securely store a pacifier 12 within a sanitary housing 40. The steps of the method include providing the nipple 14 having the sucking portion 30 and the guard portion 22. Then, providing the housing 40 having opening means 46 adapted to receive the sucking portion 30 of said nipple. Then, removably connected the housing 40 to a wrist of the user via the fastening member 60, in particular the wristband. Then, positioning the sucking portion 30 of the nipple 14 with the correspondingly shaped opening 44 of the housing in a first direction shown by arrow A. Then, inserting the sucking portion 30 through the opening 46 and into an interior cavity of the housing, in first direction A such that the enlarged sucking portion 30 of the nipple is easily received through the opening 44 of the housing 40. Then, turning the guard portion in a second direction shown by arrow B approximately 90 degrees rotationally to capture the sucking portion 30 securely within the interior cavity 43 of the housing 40.

Preferably, the sucking portion 30 is positioned entirely within the interior cavity 43 of the housing 40. By manually turning the guard portion 22 of the pacifier 12, the sucking portion 30 is securely locked within the housing. The shape of the sucking portion 30 and the uniquely designed opening means 46 secure the nipple 14 in the housing 14. The sucking portion 30 is released from the housing by manually rotating the guard portion 22 and uncapturing the sucking portion 30 from within the interior cavity of the housing.

It should be understood that numerous variations are possible, while adhering to the inventive concept. Such variations are contemplated as being a part of the present invention.

While only one preferred embodiment of the present invention has been disclosed for purposes of illustration, it is obvious that many modifications and variations could be made thereto. It is intended to cover all of those modifications and variations, which fall within the scope of the present invention as defined by the following claims.

I claim:

1. A pacifier storage device for protecting a pacifier from contaminants, said pacifier having a nipple portion and guard portion, comprising:
means for sanitarily housing said nipple portion of said pacifier;
means for securely receiving and locking said nipple portion of said pacifier with said housing means; and
means for removably connecting said housing means to an object or body part.

2. A combination pacifier and storage device, comprising:
a pacifier having a nipple having a distal end having a sucking portion and a proximal end having a shank portion, and a guard that extends laterally outward from said proximal end adjacent said shank portion; and
a housing having an interior cavity and having at least one correspondingly shaped opening to receive said sucking portion of said nipple therethrough, wherein said opening includes means for removably securing said nipple portion within said interior cavity of said housing.

3. The device of claim 2 further comprising a base portion.

4. The device of claim 3 wherein the base portion includes means for removably connecting the housing to an object or body part.

5. The device of claim 4 wherein the removably connecting means is a slot or opening for accommodating a fastening member.

6. The device of claim 5 wherein the fastening member is from the group consisting of bracelet, necklace, rope, band, string, or chain.

7. The device of claim 3 wherein the base portion is hingedly connected to the housing for opening and closing the interior cavity of the housing.

8. The device of claim 2 wherein the housing freestanding.

9. The device of claim 2 further comprising a toy, object or item having a correspondingly shaped cavity adapted to receive the housing therein.

10. The device of claim 2 wherein the opening is elongated in shape and has arcuate top and bottom ends.

11. The device of claim 2 wherein the securing means of the opening includes oppositely orientated outwardly extending protrusions of particular shape to accommodate and securing the sucking portion of the nipple within the interior cavity of the housing.

12. A combination pacifier and storage device comprising:
a pacifier having a nipple having a distal end having a sucking portion and a proximal end having a shank portion, and a guard that extends laterally outward from said proximal end adjacent said shank portion;
a storage container including a housing having an elongated opening with arcuate top and bottom ends and oppositely orientated outwardly extending protrusions of particular shape to accommodate said sucking portion of said nipple; and
means for removably connecting said container to an object or body part.

13. The device of claim 12 wherein the storage container has a base portion hingedly connected to the housing.

14. The device of claim 13 wherein the base portion includes means for connecting the container to an object or body part.

15. The device of claim 12 wherein the storage container is freestanding.

16. A method of securely storing a pacifier within a sanitary housing, the steps comprising:
providing a nipple having a sucking portion and a guard portion;
providing a housing having opening means adapted to receive said sucking portion of said nipple;
positioning said sucking portion of said nipple with said correspondingly shaped opening of said housing;
inserting said sucking portion through said opening and into an interior cavity of said housing; and
turning said guard portion of said nipple rotationally to capture said sucking portion within said interior cavity of said housing.

17. The method of claim 16 wherein the sucking portion is positioned entirely within the interior cavity of the housing.

18. The method of claim 16 wherein by manually turning the guard portion of the pacifier the sucking portion is locked within the housing.

19. The method of claim 16 wherein the sucking portion is released from the housing by manually rotating the guard portion and uncapturing the sucking portion from within the interior cavity of the housing.

20. The method of claim 16 wherein the steps further comprise removably connecting the housing by a fastening means to an object or body part.
